(19) United States
(12) Patent Application Publication
(10) Pub. No.: US 2010/0010842 A1
(43) Pub. Date: Jan. 14, 2010

(54) Computer-Implemented Systems and methods for Producing, Processing and Managing Structured Data Sets

(76) Inventors: Marcel Bank, Oberrohrdorf (CH); Michael Engel, Zurich (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/085,434

(22) PCT Filed: Nov. 23, 2006
(86) PCT No.: PCT/EP2006/011261

§ 371 Date: Aug. 6, 2009

(51) Int. Cl. G06Q 10/00; G06F 17/30

(52) U.S. Cl. 705/7; 707/100; 707/E17.005

(57) ABSTRACT

Systems and methods are provided for retrieving a product template from a product template directory to generate a contract document reflecting a contract. The product template comprises basic functions associated with a product. Distribution rules indicate whether a particular data combination can lead to a contract. The systems and methods may determine, based on the distribution rules, which conditions are fulfilled so that a customer is given access to a product associated with the basic function. A relationship may be created between a distribution rule and a basic function allocated to the distribution rule. The systems and methods provide functionalities for implementing contract data and for managing and administering customer contracts relevant to a customer.

### BACKGROUND OF THE INVENTION

In many companies but also in authorities, today in connection with the performance of services, the establishment and performance of business relations or the performance of State tasks, huge quantities of data occur. A structured and systematic technical definition, production, processing, administration and presentation of the services performed, relationships concluded or similar are required.

Only in this way can the backgrounds and details of the procedures connected with the data be reviewed at any time. One example of a service provider are banks. In banking in recent years or even decades, there has been increasing differentiation of services and prices offered. Formerly uniform services (current account, deposit etc.) with few variants have been replaced by an ever increasing number of different services and price alternatives. The range of financial instruments offered becomes ever wider and the individual financing instruments are more customer-orientated and complex.

At the same time, the customer/partners on one side and the internal auditors and official authorities (supervisory authorities etc.) on the other, impose ever higher demands on the service provider in relation to transparency, consistency and completeness of data/information provided to the customer/partner by the service provider and which are produced and archived in connection with the business relationship.

When for example in a bank a ‘product’ is sold to a customer/partner, a contract is concluded. The contract establishes the agreements between bank and customer/partner, i.e. which rights and obligations are incumbent firstly on the bank and secondly on the customer/partner. As well as basic information, above all the individual features of the product are included.

Problem on which the Invention is Based

One problem with the production, processing and administration of structured data sets, such as for example those which form contracts between bank customers and a bank, lies in that the bank firstly needs as many similarly structured products in its range as possible but secondly wants/needs to meet customer/partner wishes. More and more, the circumstance must be taken into account that customer advisors are not always informed of all possibilities and also restrictions which could be important in connection with a product. In addition, the bank's professional check of ‘individually’ agreed contracts can be extremely costly.

A second problem is that with conventional definition, production, processing and administration of products/contracts/services, the data maintenance cost incurred rises substantially as the individual agreements are difficult to store in comprehensible but simultaneously compact form.

Furthermore the typifying of products/contracts/services and their processing in conventional procedures is very difficult, which is reflected in rising data traffic and increased susceptibility to error with associated extra costs.

Finally the development of new products takes a relatively long time in conventional procedures. This is due in particular to rising standards of compliance with legal requirements, and the increased cost of implementation and testing in the complex IT environment of such service providers today, for example the bank or other organisation.

WO 03/042861 A2 discloses a method and a device for computer-implemented production and administration of contracts. In particular a method and a device are known for computer-implemented administration of financing processes and in particular for production and administration of contracts in connection with financial services. This publication describes the computer-supported production and administration of contracts between a supplier and a customer. The contracts comprise key data in a contract object product and one or more contract modules. To structure a contract, a selection is made of key data and contract modules, and a selection of contract modules. The contract is produced on the basis of the selection made by generation and storage of pointers to the selected key data and contract modules. First a selection of key data is made and then a selection of contract modules. On the basis of these selected key data, which contain information and rules on the product which is the object of the contract, the reliability of the selection of individual contract modules is checked automatically. This document explains only that a selection of key data and a selection of contract modules is made, and that on the basis of the selection made the contract is generated by production and storage of so-called pointers to the selected key data (=information and rules on the contract object product) and contract modules. This document describes a set of rules only in connection with the material provision of blocks and limits on associated payment postings. These “Posting control rules” control the reaction of the system using preset parameters in order, for example, to determine specific to customer group whether a transaction should be arranged or paid directly.

Document EP 1 286 283 A2 describes interface modules for performance of document-based electronic business processes on a transaction basis and a system for performance of electronic business processes on a transaction basis. Thus the performance of document-based electronic transactions between heterogenic systems is facilitated. An interface module comprises a module for display and monitoring of the useful data flow. This display and monitoring take place on a document basis. The transfer of the displayed useful data to and from a terminal can take place manually or automatically. The document templates can be entered into or modified in the file system of the interface module from a master server in the data network. On a change in configuration of interface module, parameters of processes concerned of work flows formed by means of document templates can be adapted automatically. The document templates and/or a complete workflow can be coupled by means of a mapping unit into a database with predetermined destinations in the data network.

### OBJECT OF THE INVENTION

The object of the invention is to indicate a way of allowing, for a multiplicity of different types of products of a service provider, for example a bank or other organisation, a structured and systematic definition, production, processing and administration of structured data sets such as those which describe the services and ‘products’ of a bank, at the level of electronic data.

### Solution According to the Invention

To achieve this object according to the invention-a contract manager is provided in order to retrieve from a product template directory containing the structures of the product templates stored in a structured manner, a product template for individualisation and specifically supplement this in that either at least one preset value is to be transferred or a value selected within a permitted range in order to generate a individualised contract document reflecting a contract, and trigger the storage of this contract in a database and its technical processing, wherein the contract has a contract header and at least one basic function derived from the product template, wherein the software program component contract manager provides functionalities for managing the contract data and all customer-/partner-relevant customer contracts are managed and administered, characterised in that at product template level distribution rules are implemented, a distribution rule being an independent object with its own identification and a descriptive text, the distribution rules are provided by a rule base, and a distribution rule determines which conditions are to be fulfilled in order for a customer/partner to be given access to a product with the basic function concerned, a relationship is created between a distribution rule and its allocated basic function, and distribution rules can also be used across several basic functions of a product template.

In other words the invention provides that a contract is based on a product template which the customer advisor specifically supplements in consultation with the customer/partner. Here either the pre-set value (default) is used or a value within the permitted range is selected individually for the customer/partner. Conclusion of the contract, i.e. the sale of a product, triggers two main activities on the side of the service provider (bank). Firstly a physical contract document is produced which is usually signed by both parties and given to the customer/partner. Secondly storage of a contract in the (bank) internal data processing and the technical processing of the contract are triggered.

According to the invention the contract consists of a contract header and at least one basic function. The basis for the contract is the completed product template i.e. the product sold. From the product template the contract header is derived and from each basic function included in the contract, a basic function contract is produced. The basic functions can have different origins. Depending on origin of the basic function i.e. depending on the identity of the basic function producer, different basic function contract data are contained in the contract. Basic functions from particular producers with their own data management are shown in the contract merely as a key. The actual basic function contract is passed onto the producer of the basic function.

Producers without their own data management simply store their basic function in a separate database. This basic function contract data are stored in the contract. Information on pricing, instructions and even interest do not appear in the contract. Storage and retrieval take place directly via the corresponding software program component. An extract from the most important contract data is replicated in a contract directory which is available as a reference directory.

The software program component contract manages and administers all customer-/partner-relevant customer contracts. The software program component contract provides services for definition of the contract data. In relation to third party software program components, the contract-specific functionalities/services are always retrieved by a software program component contract manager and never directly. One condition for opening a contract is the presence of a partner or corresponding business relationship. Each contract must consequently be able to be allocated directly to a business relationship or a partner. The contracts are always defined by the software program component contract manager. The basis for opening a contract is the product template. The product template specifies all necessary information such as value ranges, defaults, compulsory and optional fields for conclusion of a contract. The individual features of a sold product, defined on the basis of the defaults in the product template, are depicted in the contract. The contract consequently is based in structure and content on the product template i.e. each contract refers to a corresponding product template.

The contract header is derived from the product template and forms the envelope for the basic function contracts belonging to the contract. The contract header contains different keys (product template ID and contract header ID). In addition further information such as for example lifecycle information (status, opening date etc.) are contained in the contract header.

The basic function contract is based on the basic functions defined in the product template. On the basis of the different basic function types or producers, the basic function contracts differ in scope of information contained in the contract.

Basic function producers with their own data management, to process their transactions, have their own physical data representation (i.e. table/data model) of their basic functions. In this case the contract data of the basic function contract is fully contained in the data records of the basic function producer.

On contract conclusion the complete basic function contract is transmitted via an interface to the corresponding basic function producer who stores the data accordingly in his database component.

The contract itself contains only references (keys) which point to the corresponding basic function producer or holder of the basic function contract.

For basic function producers with separate data management, software program components are used which do not contain their own physical representation of the basic function but store this completely in the product. On contract conclusion the complete basic function contract is stored in the contract; depending on origin of the basic function, the basic function contract may be only partially depicted.

‘References’ are for example prices, instructions and interest. These are not stored in the contract even as references (keys). The prices, instructions and interests belonging to a contract must be determined by corresponding querying of the software program component containing the data.

The invention furthermore concerns a computer program product which is designed to implement a system defined in any of the preceding claims when processed by a computer or computer network. The computer program product can for example be stored on a computer-legible magnetic or optical information carrier (such as a CD ROM).

### BRIEF DESCRIPTION OF THE DRAWINGS

The invention is explained in more detail below with reference to the enclosed drawings.

FIG. 1 shows diagrammatically a computer system and the computer program components present in the computer system and their interaction.

FIG. 2 shows diagrammatically the correlation between basic function, product template and contract.

FIG. 3 shows diagrammatically the processing of rules by the software program component contract manager.

FIG. 4 shows diagrammatically how a contract is produced from a product template.

FIG. 5 shows diagrammatically the structure of rules and their interaction with the basic functions and product templates.

FIG. 6 shows diagrammatically the retrieval of rules by the software program component contract manager.

### DETAILED DESCRIPTION OF EMBODIMENT EXAMPLE

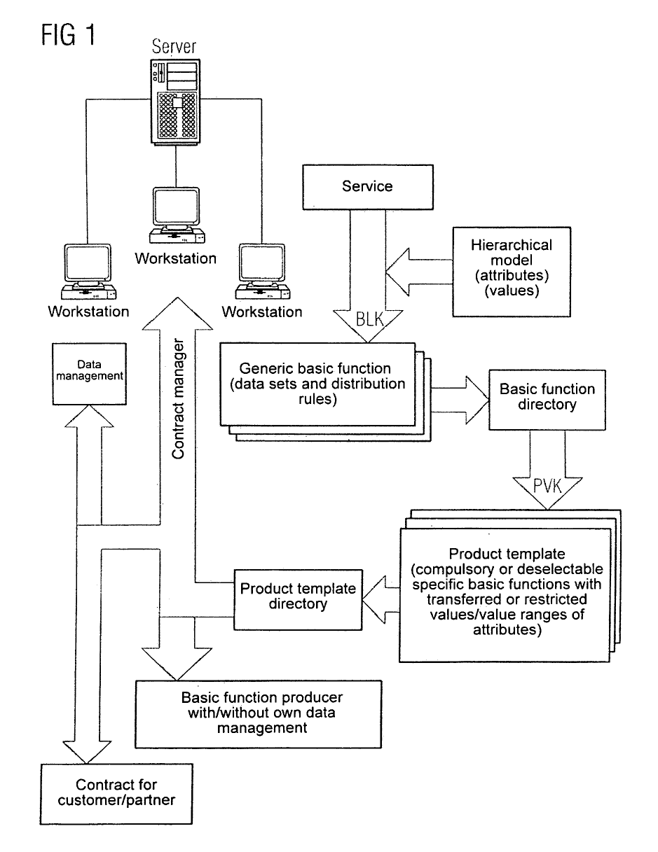

FIG. 1 shows a computer-implemented system for producing, processing and managing structured data sets. This system has one or more servers for data and/or program management and a multiplicity of workstations which are connected with the server for data or program exchange. In this system a computer software program component basic function configurator BLK is provided. The basic function configurator BLK serves to define a generic basic function. A generic basic function depicts at least one function performed or to be performed according to a hierarchical organised model. For this by means of descriptive attributes and associated values or value ranges necessary for processing the basic function, the generic basic function is structured and depicted on one or more data sets, to each of which is allocated at least one distribution rule. The data sets together with the allocated distribution rules each define a generic basic function.

Furthermore a basic function directory BL-DICT is provided in which the data sets defining the generic basic functions together with their associated distribution rules are stored in a structured manner as a database for access by a computer software program component product template configurator.

The product template configurator PVK is intended to combine one or more basic functions from the database in the basic function directory and transfer these into a product template POT, in that the generic basic functions are mutated into specific basic functions for the product template concerned by transfer or restriction of values and/or value ranges for the attributes. For this a product template POT comprises one or more basic functions which compulsorily belong to a product. It can also comprise one or more basic functions to be expressly added to or deselected from a product.

The product templates are stored in a product template directory. Here the complete structure of the product templates is stored in a structured manner for access by a computer software program component contract manager and depiction on a graphic or alphanumeric user interface GUI.

In order to retrieve and specifically supplement a product template for individualisation from the product template directory in which the structures of the product templates are stored, by means of the contract manager either at least one preset value must be taken or a value selected within a permitted range. In other words the permitted range is (further) restricted. Thus an individualised contract document reflecting the contract is produced, and the storage of this contract in a database and its technical processing are triggered.

The contract comprises a contract header and at least one basic function derived from the product template. From each basic function included in the contract a basic function contract is derived, from which predetermined basic function contract data are transmitted to the respective basic function producer. For producers with their own data management, in the contract the basic function contract data are kept as a key and for producers without their own data management, these basic function contract data are stored in the contract. The software program component contract manager provides functionalities for defining the contract data available and manages and administers all customer-/partner-relevant customer contracts.

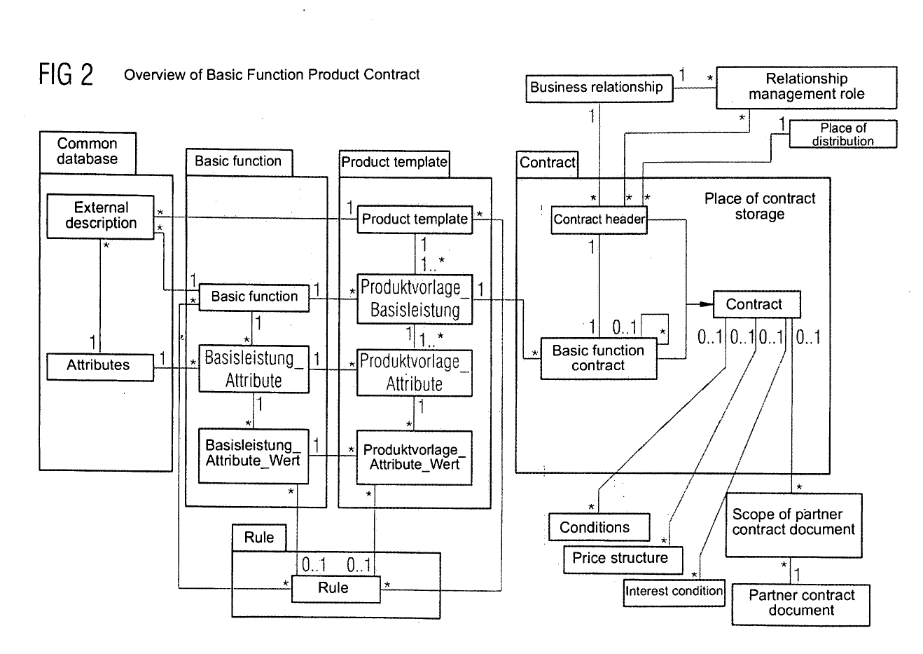

FIG. 2 shows the correlation and relationships between basic function(s), rule(s), product template(s) and contract in further detail.

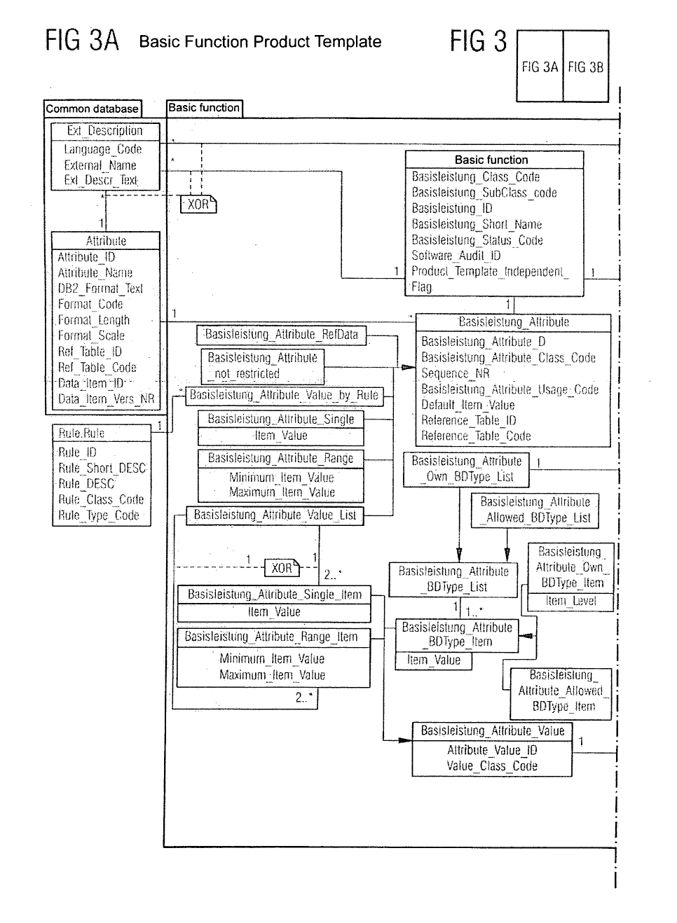

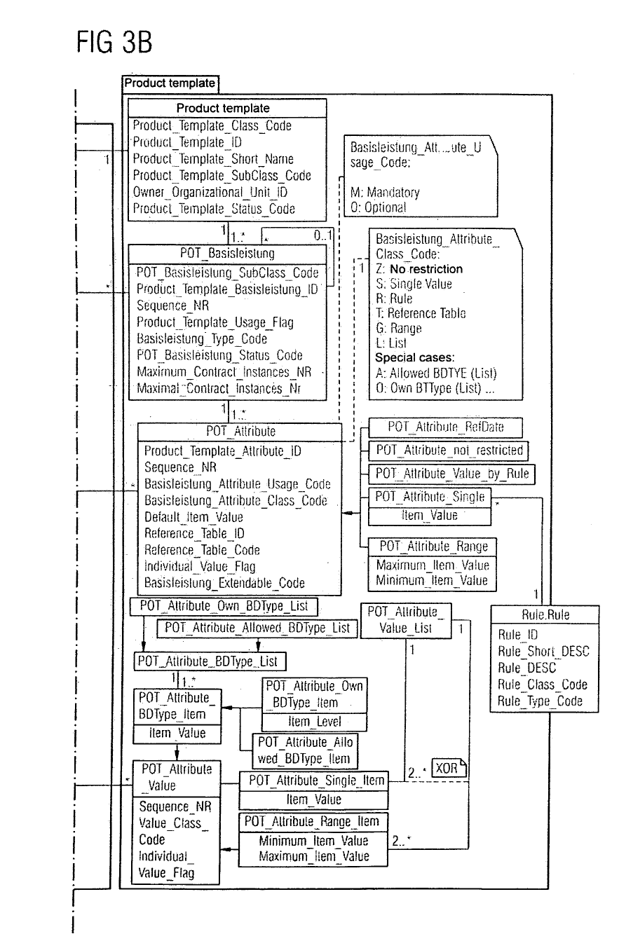

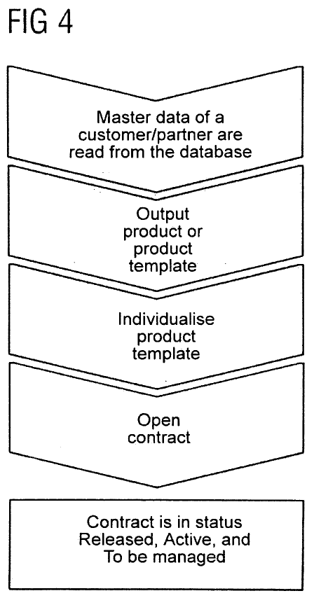

A data structure of a basic function according to the invention can have the following structure (see FIG. 3):

| | |
|---|---|
| Class: | |
| Attribute | |
| Attribut_Directory | Directory of all attributes with which |
| | basic functions and/or rules are defined. |
| Attribute: | |
| DB2_Format_Text | Physical DB2 format of the attribute |
| Attribute_ID | Standard identifier of an attribute which |
| | is used in a basic function, rule or |
| | similar |
| Attribute_Name | Name of the attribute which is used in a |
| | basic function, rule or similar |
| Physical_Format_Text | Physical DB2 format, e.g. SMALINT, CHAR(16) |
| Format_Code | Format of defined attribute. |
| | Code list |
| | C Code |
| | D Date |
| | I Identifier |
| | N Number |
| | Q Quantity |
| | T Text |
| Format_Length | Total length of field (inc. decimal places) |
| | for use in a basic function, rule or |
| | similar |
| Format_Scale | Decimal places for data type Decimal |
| | (otherwise zero) for use in a basic |
| | function, rule or similar |
| Reference_Table_ID | Id of reference table. May only be filled |
| | if the attribute has FORMAT_CODE = “C” |
| | (code) e.g. |
| | CNTRY |
| | R10000 |
| Reference_Table_Code | Code number of code table |
| | (e.g. code number contains Ref_Table |
| | R10001) |
| | Only filled if field REFERENCE_TABLE_ID is |
| | filled with value “R10000’. |
| Data_Item_ID | External key to data item catalogue |
| Data_Item_Version_NR | Version of referenced data item from data |
| | item catalogue basic function |
| Class: | |
| Basic function | Basic functions available for definition of |
| | products |
| Attribute: | |
| Basisleistung_ID | Technical STID of a basic function |
| Basisleistung_Short_Name | Short name of basic function for searching. |
| | The short name is a unique, alternative |
| | search key |
| Basisleistung_Status_Code | Status of basic function; to form products, |
| | only basic functions of status = 2 |
| | (productive) may be used. |
| | Code list |
| | 1 Development |
| | 2 Production |
| | 3 Out of service |
| Software_Audit_ID | The ID of the physical instance of the |
| | software sub-component (see I-SAC), |
| | supplier of basic function from other |
| | software program components. Example: “HQE: |
| | Card Lifecycle Data” |
| Product_Template_Independent_Flag | Identifies whether the basic function |
| | can be used as an independent basic |
| | function |
| | 0 = No (can only be used as allocated or |
| | service basic function) |
| | 1 = Yes (also possible as independent |
| | service basic function) |
| Basisleistung_Class_Code | Defines whether a basic function is |
| | attached to the contract header or the |
| | basic function contract |
| | Code list |
| | BL Basic function |
| | CH Contract header |
| Class: | |
| Basisleistungs_Attribute | Attribute used in a basic function |
| Child_Class: | |
| Basisleistung_Attribute_not_restricted | |
| Basisleistung_Attribute_Range | |
| Basisleistung_Attribute_Single | |
| Basisleistung_Attribute_Wert_By_Regel | |
| Basisleistung_Attribute_Wert_List | |
| Attribute: | |
| Basisleistung_Attribute_ID | Standard identifier of an attribute which |
| | is used in a basic function |
| Sequence_NR | Serial number of the attribute in a basic |
| | function |
| Basisleistung_Attribute_Class_Code | Defines the restriction of the value |
| | range of an attribute in a basic function |
| | Example: |
| | L: Only values from the attribute list are |
| | valid |
| | G: Values within a range are valid |
| | R: Valid values are defined by a rule |
| | Code list |
| | F fixed |
| | N not restricted |
| | R restricted |
| Basisleistung_Attribute_Usage_Code | Establishes whether the attribute is |
| | optional or mandatory in a product |
| | template. Coex is a special case of |
| | mandatory |
| | Code list |
| | C COEX |
| | M Mandatory |
| | O Optional |
| Default_Item_Wert | Default value of an attribute used in a |
| | basic function, rule or similar |
| Reference_Table_ID | Id of reference table. May only be filled |
| | for an attribute with FORMAT_CODE = “C” |
| | (code) e.g. |
| | CNTRY |
| | R10000 |
| Reference_Table_Code | Code number of code table (e.g. code number |
| | within Ref_Table; is only filled if field |
| | REFERENCE_TABLE_ID contains value “R10000’. |
| Class: | |
| Basisleistung_Attribute_not_restricted | Attribute used in a basic |
| | function, the valid values of which are not |
| | restricted, i.e. all values in class |
| | “Attribute” are permitted. |
| | Corresponds to attribute class code = “Z” |
| Parent_Class: | |
| Basisleistung_Attribute | |
| Attribute: | |
| Basisleistung_Attribute_not_restricted: | |
| Basisleistung_Attribute_Wert_List | Attribute used in a basic function, |
| | the valid values of which are established |
| | individually by a list of values and/or |
| | ranges. |
| | Corresponds to attribute class code = “L” |
| Class: | |
| Basisleistung_Attribute_Value | |
| Parent_Class: | |
| Basisleistung_Attribute | |
| BL_Attribute_Value | Valid individual value or value range of an |
| | attribute used within a product template |
| Class | |
| Child_Class: | |
| Basisleistung_Attribute_Range_Item | |
| Basisleistung_Attribute_Single_Item | |
| Value_Class_Code_Attribut | Defines the type of a concrete value within |
| | a value list |
| Attribute_Wert_ID_Attribut_Datastandard | Unique identification of an |
| | attribute value or value range for |
| | use in a basic function, rule or |
| | similar |
| Basisleistung_Attribute_Single_Item | Valid individual value of an |
| | attribute class used in a basic function |
| Parent_Class: | |
| Basisleistung_Attribute_Wert | |
| Attribute: | |
| Item_Wert | Valid individual value |
| Basisleistung_Attribute_Wert_By_Regel | Attribute used in a basic function, |
| | the value of which is firmly defined by a |
| | rule. |
| | Corresponds to attribute value class code = |
| | “R” |
| Class: | |
| Parent_Class: | |
| Basisleistung_Attribute | |
| FK_Regel_ID (Regel) | |
| Attribute: | |
| Datastandard: | Reference (STID) of a rule which context- |
| | dependent determines the value of the |
| | attribute |
| Class: | |
| Basisleistung_Attribute_Wert_By_Regel | |
| Basisleistung_Attribute_Range | |
| BL_Attribute_Wert_Range | Valid value range of an attribute class |
| | used in a basic function |
| Parent_Class: | |
| Basisleistung_Attribute | |
| Attribute: | |
| Minimum_Item_Wert | Minimum value of the value range |
| Maximum_Item_Wert | Maximum value of the value range |
| Basisleistung_Attribute_Range_Item | Valid value range of an attribute |
| | class used in a basic function |
| Parent_Class: | |
| Basisleistung_Attribute_Value Attribut: | |
| Minimum_Item_Value | Minimum value of the value range |
| Maximum_Item_Value | Maximum value of the value range |
| Basisleistung_Attribute_Single | Attribute used in a basic function, |
| | the value of which is firmly defined by a |
| | value (value). |
| | Corresponds to basic function attribute |
| | class code = “S” |
| Class: | |
| Parent_Class: | |
| Basisleistung_Attribute | |
| Attribute: | |
| Item_Value | Valid individual value |
| Basisleistung_Attribute_Value | Valid individual value or value range |
| | of an attribute used in a product template |
| Class: | |
| Datastandard: | |
| Attribute: | |
| Basisleistung_Attribute_Value | |
| Class | |
| RuIe | |
| Child_Class | Dynamic_RuIe |
| | Static_RuIe |
| Attribute: | |
| Rule_ ID | |
| Rule_ Short_DESC | Brief designation of a rule |
| Rule_ DESC | Detailed description of a rule |
| RuIe_Class_Code | Defines whether it is a dynamic or a static |
| | rule |
| | Code list |
| | D Dynamic |
| | S Static |
| Rule_Type_Code | States what type of rule is concerned: |
| | Eligibility rule (distribution rule), |
| | Validation rule, or Attribute rule (valid |
| | value, default, etc.) |
| | Code list |
| | A Attribute rule |
| | E Eligibility rule |
| | V Validation rule |
| Class: | |
| External_Description | Language-dependent descriptions (name, |
| | definition) of attributes, basic functions, |
| | products and rules |
| Attribute: | |
| Language_Code | Language (in ISO format) |
| | Code list |
| | de German |
| | en English |
| | es Spanish |
| | fr French |
| | it Italian |
| | pt Portuguese |
| External_Name | External name of an attribute, in the given |
| | language, of a basic function, a product |
| | or a rule, which e.g. is used to label the |
| | graphic user interfaces (GUIs). |
| External_Description_Text | Description of an attribute, in the given |
| | language, of a basic function, a product or |
| | a rule. |

A product is produced from one or more basic functions. For this a basic function directory (BL-DICT) contains basic functions (BL) from providers/business areas with the following states:
Basic function released and active for product configuration
Basic function released and inactive for product configuration
Basic function not released and inactive for product configuration (no more contracts may be issued).

The steps are described below with which a product is configured, in that a product template (POT) is produced (or an existing product template (POT) re-used in the manner of a template):
Define product template (short text, long text, identifier, status etc)
Import one or more basic functions from the basic function directory (BL-DICT)
Basic function must be released and active
Basic function is instanced as a product template basic function
On the product template basic function (POT-BL) the following actions are performed:
Its status is changed to “in processing”
Rules are defined for the product template basic function
Define permitted business case types (a basic function can have several business cases, for example basic function Account has business case types Monthly statement, Intermediate statement or Annual statement)
Establish or restrict attribute value ranges (within the permitted values of the basic function)
Establish default values of the attributes.

When creating a product template from one or more basic functions, the status of the basic functions included is set at that which is productive at the time of production of the product template. This is irrespective of whether or not adaptations are made to the basic functions in the product template. This referencing applies until the next explicit mutation of the product template. Consequently there are no “sliding” or automatic updates of product templates.

A check function is provided in order if necessary to detect those product templates which use basic functions that are mutated after production or the last mutation of the product template. On the basis of this it must be checked whether the product template concerned can continue to be used sensibly. In particular individualisation of basic functions in a product template and the allocation of rules to a product template must be checked. If a product template is brought to the latest state of the basic functions contained therein, an explicit mutation to the header data of the product template is required. For this an entry is made on the existing product template ID with the current time stamp.

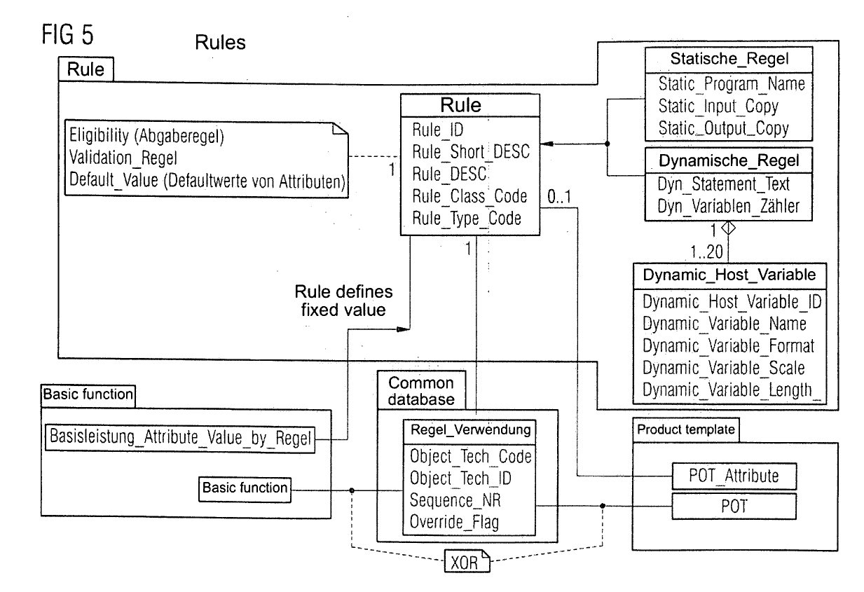

From a product template a contract is produced by the following actions being performed (see FIG. 5):
The master data of a customer/partner are read from the corresponding database.
Check for products suitable or permitted for the customer/partner
Issue of the product list of all suitable/permitted products
The associated product template is read.
Input: product template ID and partner ID
Checking of distribution rules
Output of product or product template on the graphic/alphanumeric user interface
Individualisation of product template in that
Attributes are adapted within the possible value ranges
Open contract by
Checking distribution rules
Creating the business case “Open contract” in the database of the bank
The contract is entered in the software program component “Contract” and in the contract directory
Any instructions and redemptions are applied
Corresponding software program components are added
The software program components “Price structure” and the attribute derivation (for account products) receive messages with partial or complete data on the contract

In the formation of a contract, the metadata of the basic functions and product templates are accessed. On the basis of this information it is known which software program components or business subsystems/solution areas can or must be involved in the contract concerned. It is also known by means of which attributes/interfaces data can be exchanged by the corresponding components.

The metadata of the basic function, in particular the basic function contained in a product template, contains in addition to the structural data also permitted value ranges of the basic function attributes. These value ranges are usually established by the corresponding software program components and describe the permitted values. The value ranges can be quite complex even in basic function definition e.g. combinations from lists of individual values and value ranges can be depicted. This also applies to references to other tables e.g. reference data. From the aspect of the individual attribute they are static value ranges which may not be adequate, for example if a value range is given for an attribute which is defined by means of a data-dependent formula. For such certainly less common cases, the rule basis can be used as a solution in that for the attribute of the basic function as a value the key of the rule is given which performs the complex validation.

Also with regard to a basic function a value range definition per attribute may not be adequate. A definition of value ranges across attributes is possible.

For example if attribute A assumes value A1, attribute B may only assume values B1, B2 and B3; in all other cases the value range B10 to B100 is permissible for attribute B.

Also with regard to a product template the attribute-specific definition of value ranges may not be sufficient. For the above cases i.e. for dynamic value ranges of individual attributes and for all value range checks across attributes, corresponding rules are made available via the rule basis. The rules contained therein are formulated for reusability so that as many checks as possible on different attributes, basic functions and product templates can be performed with as few rules as possible. To allow this reusability, a relationship is explicitly created between a rule and its allocated object (attribute, basic function, product template). Although a relationship can be created between each object and each rule, the following precondition applies:

For rules there is no lifecycle in the rule base. Static and dynamic rules differ. In the rule base for static rules, only the information Program name, Input/output copybook name is contained. Content mutations of rules are therefore not included in the rule basis but in the reference to program. Dynamic rules are functionally limited and only provided for prototyping purposes. The relationship between rule and product template is provided in the model as a relationship entity. Here it is possible to add or remove rules subsequently during the lifecycle of a product template without the product template itself having to be altered. To correctly depict a product template, a lifecycle is managed for this relationship so that at each time in the contract the correct i.e. current valid rule is used and processed. Dynamic rules usually consist of an SQL statement and are prepared and executed by a driver program available for this. The convention is that for SQLCODE 0 (zero) the value OK is used and for SQLCODE 100 the value NOK, and for all other SQLCODES the value DB-ERROR (this is a special case for NOK) is returned. The rule base contains, as well as the SQL statement text, also descriptive information on the variables which must be provided for performance of the rule. In production because of the greater stability and speed, only static rules are executed. As the rule base for a rule contains the program name and input and output copybooks, for performance of static rules a general driver program can also be provided.

For validation rules the dynamic value range of an attribute should not be structured across attributes. Instead of the static value of an attribute the key of the rule is entered. This means at the same time that in this case precisely one rule is allocated to the attribute. For value range checking across attributes, for attributes of a basic function or a basic function in a product template, an explicit (n:m) relationship is generated between a basic function or a basic function in a product template and a rule of the rule base. Thus a basic function can have relationships with several rules and a rule can be used in several basic functions.

Distribution rules can be used across several attributes of a product template i.e. also across several basic functions of this product template. Thus rules can assume considerable complexity.

All the above rule types are “hard” rules i.e. they indicate whether a particular data combination can or cannot lead to a contract.

Thus it is recommended to implement distribution rules only at product template level. The definition of distribution rules at the level of the basic function greatly restricts the reusability of the basic function.

A rule is an independent object with its own identification (STID) and a descriptive text of 160 Bytes. The argument of a rule is a list of parameter values. The return values of a rule are usually OK or NOK.

In processing types of a rule we distinguish between static (which integrates a program with fixed input and output interface (copybook)) and dynamic (integrated statement text of an SQL statement with parameter markers in which the WHERE condition result are divided into SQLCODE 0=OK, SQLCODE 100=NOK and other codes=ERROR.

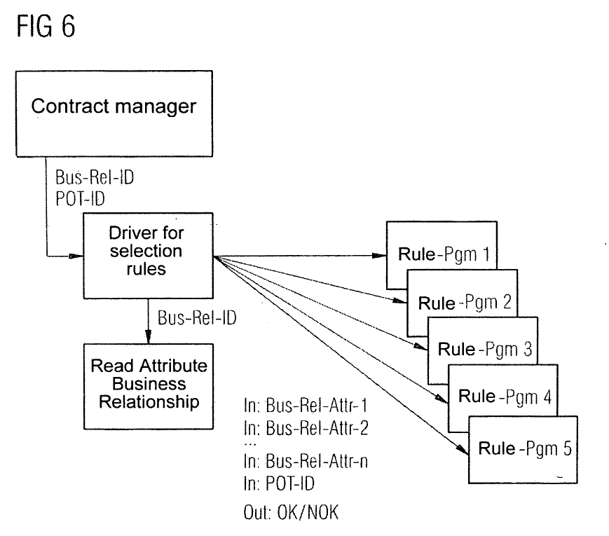

As FIG. 6 shows, a rule is retrieved such that the software program component contract manager can receive the rule ID and the input values for the rule e.g. from the GUI. Thus a generic rule driver is retrieved which reads the rule table. The rule is then executed statically or dynamically (static for production mode, dynamic for prototyping in development). The information on the rules in the rule table in the static case is the program name and input/output interface (=copybooks) and in the dynamic case an SQL statement text with parameter markers (spacers for variables) with for example around twenty variables, information on name, format of variables.

In a static rule all copybooks of all static rules are known to the rule driver. The transferred parameter values are transferred in the fields of the copybook. Then a retrieval takes place of the type “CALL program USING copybook-in, copybook-out”. An OK or NOK is returned from the rule driver.

In a dynamic rule the parameter markers are replaced in the statement text by transmitted values. The parameter formats are known from the rule table (numeric, character, date-time, . . . ). The rule is then processed by PREPARE and EXECUTE the statement text. SQLCODE 0 gives OK, SQLCODE 100 gives NOK, otherwise DB-Error.

The distribution rules are retrieved for example if a customer/partner wishes to receive a particular service. Based on a search function, the program component contract manager has a list of POT's which contain relevant basic functions. The program component contract manager for each of these POT's retrieves a rule driver which checks the distribution suitability of the POT for the customer concerned. For this the rule driver inputs the business relationship ID and the POT ID. The output from the rule driver is then OK/NOK.

The rule driver executes the following activities: read data on business relationship ID and read rule use with POT ID. Then each rule program is retrieved with the following interface: attribute to business relationship ID, POT ID and return of rule program OK/NOK.

On the first NOK the retrieve of the rule program is interrupted and the contract manager receives NOK.

To ensure a static value range (including reference tables) no rules are required in the rule base as these have already been provided by tables for the attribute values.

The data on basic functions (BL) and product templates (POT) are managed so that each mutation of these objects can be clarified and reconstructed at any time. Mutations can have ad hoc validity in online operation. Mutations are also permitted in the future. For stability and handling considerations the current valid state of a basic function or product template is defined by convention (recommendation) as the state valid for the current date at zero hours.

As well as this principle there are the following conventions and application processes which are provided for managing basic functions and product templates:

A basic function can be mutated as follows:
Addition/removal of attributes
Change of permitted value range of attributes

These mutations are triggered by the processing of software program component (basic function producer). The addition or removal of attributes is a massive intervention which occurs relatively rarely. In the same way as a change to basic function, the interface must also be adapted.

1-35. (canceled)

36. A computer-implemented system for producing, processing, and managing structured data sets, the system comprising:
a contract manager for retrieving from a product template directory, which stores structures of product templates, a product template to generate an individualized contract document reflecting a contract and to trigger the storage of the contract in a database by transferring at least one preset value or selecting a value within a permitted range, the product template comprising basic functions associated which a product and further comprising basic functions to be associated with or disassociated with the product, wherein:
the contract comprises a contract header and at least one basic function derived from the product template;
a basic function contract is derived from the basic function included in the contract;
preset basic function contract data are transmitted to a basic function producer;
the basic function contract data are shown as a key for producers with their own data management;
the basic function contract data are stored in the contract for producers without their own data management;
the contract manager provides functionalities for implementing the contract data and for managing and administering customer contracts relevant to a customer;
distribution rules, implemented at the level of the product templates, indicate whether a particular data combination can lead to a contract, wherein a distribution rule is an independent object and include an identification and a descriptive text;
the distribution rules are made available by a rule base;
a distribution rule determines which conditions are to be fulfilled so that a customer is given access to a product associated with the basic function;
a relationship is created between a distribution rule and a basic function allocated to the distribution rule;
distribution rules are used across several basic functions of a product template;
static rules are executed in production of the contract;
the contract manager retrieves a generic rule driver and the distribution rules are checked; and
the contract manager has a search function which provides a list of product templates for a particular desired function, the contract manager for each of the product templates retrieving a rule driver which checks the distribution ability of the product template for the customer.

37. The computer-implemented system of claim 36, wherein an extract from predetermined contract data is replicated in a contract directory.

38. The computer-implemented system of claim 36, wherein the contract header derived from the product template forms an envelope for the basic function contracts associated with the contract, and the contract header contains various keys.

39. The computer-implemented system of claim 36, wherein the basic function contract is based on the basic functions defined in the product template.

40. The computer-implemented system of claim 36, wherein the distribution rules comprise at least one of an age, a domicile, a customer segment, and legal restrictions.

41. The computer-implemented system of claim 36, wherein the distribution rules in the contract cannot be overruled.

42. The computer-implemented system of claim 36, wherein the distribution rules with legal restrictions are transferred to the contract on product configuration.

43. The computer-implemented system of claim 36, further comprising validation rules for checking the values or the value ranges of the attributes are observed in the contract and further checking whether inputs in fields are correct based on field formats.

44. The computer-implemented system of claim of claim 43, further comprising returning OK or NOK as a result.

45. The computer-implemented system of claim 36, wherein the contract manager is further adapted to individualize a contract including validation rules for pre-selecting and checking product templates for which a contractual relation is opened or modified for a customer, the validation rules returning a result set based upon the checking.

46. The computer-implemented system of claim 45, wherein validation rules determine a preset value specific to a customer before or during displaying the value on a user interface.

47. The computer-implemented system of claim 36, further comprising validation rules for checking at least one of a value, a value range, or a data set specified in the product template to ensure processability of a basic function.

48. The computer-implemented system of claim 36, wherein the data associated with a contract are managed so that manipulation of the data can be clarified and reconstructed at any time and the storage duration of contract data which are no longer valid is established as an attribute.

49. The computer-implemented system of claim 36, wherein a change of an attribute of the contract header triggers the production of a new entry in the contract header.

50. The computer-implemented system of claim 36, wherein an attribute is stored in the contract header, and a change of the attribute does not trigger production of a new entry in the contract header but triggers an update of the attribute.

51. The computer-implemented system of claim 36, wherein a change of an attribute of a basic function contract triggers at least one of production of a new entry in the basic function contract and an update of the attribute in the contract header.

52. The computer-implemented system of claim 36, wherein a reference is generated to a product template or a basic function for the product template on production of an individualized contract header or on production of a basic function contract.

53. A computer-implemented method for producing, processing, and managing structured data sets, the method comprising:
retrieving from a product template directory, which stores structures of product templates, a product template for individualization and specific supplementing;
transferring at least one preset value or selecting a value within a permitted range, the product template comprising one or more basic functions associated with a product and one or more basic functions to be associated or disassociated with the product;
generating an individualized contract document reflecting a contract;
triggering the storage of the contract in a database, the contract comprising a contract header and at least one basic function derived from the product template;
deriving a basic function contract from each basic function included in the contract;
transmitting preset basic function contract data to a respective basic function producer;
showing the basic function contract data as a key for producers with their own data management;
storing the basic function contract data in the contract for producers without their own data management;
providing functionalities for managing the contract data;
managing and administering customer contacts relevant to a customer;
implementing distribution rules at the level of the product templates, the distribution rules indicating whether or not a particular data combination can lead to a contract, wherein a distribution rule is an independent object and includes an identification and a descriptive text;
making the distribution rules available by a rule base;
determining, based on the distribution rules, which conditions are fulfilled so that a customer is given access to a product associated with the basic function;
creating a relationship between a distribution rule and a basic function allocated to the distribution rule;
using the distribution rules across several basic functions of a product template;
executing static rules in production;
retrieving a generic rule driver by checking the distribution rules;
providing a list of product templates for a particular desired function; and
retrieving a rule driver which checks the distribution ability of the product template for the customer.

54. The computer-implemented method of claim 53, further comprising replicating an extract from preset contract data a contract directory, the contract header derived from the product template forming an envelope for the basic function contracts associated with the contract, the contract header containing various keys.

55. The computer-implemented method of claim 53, wherein each basic function contract is based on the basic functions defined in a product template.

56. The computer-implemented method of claim 53, further comprising:
allocating at least one distribution rule to each basic function; and
determining, based on the distribution rules, which conditions are fulfilled so that a customer has access to a product associated with the basic function, the distribution rules comprising at least one of an age, a domicile, a customer segment, and legal restrictions,
wherein the distribution rules in the contract cannot be overruled and the distribution rules with legal restrictions are included in the contract on product configuration.

57. The computer-implemented method of claim 53, further comprising:
checking, based on validation rules, at least one of whether values or ranges of attributes are observed and whether inputs in fields are correct based on field format;
individualizing a contract by pre-selecting and checking product templates for which a contract relationship is opened or modified for a customer; and
returning as a result OK or NOK.

58. The computer-implemented method of claim 53, further comprising:
individualizing a contract including validation rules by determining a preset value specific to a customer before or during displaying the value a user interface; and
checking, based on validation rules, observation of at least one of a value, a value range, and a data set specified in the product template to secure the processability of a basic function.

59. The computer-implemented method of claim 53, further comprising managing the data associated with a contract so that each manipulation of data can be clarified and reconstructed at any time, the storage period of contract data which is no longer valid being established as an attribute.

60. The computer-implemented method of claim 53, further comprising storing at least one derived attribute in the contract header, wherein a change of an attribute of the contract header triggers production of a new entry in the contract header.

61. The computer-implemented method of claim 53, wherein a change in a derived attribute does not trigger production of a new entry in the contract header, but triggers an updating of the attribute.

62. The computer-implemented method of claim 53, wherein a change of an attribute of a basic function contract triggers a production of a new entry in the basic function contract and an update of the attribute in the contract header.

63. The computer-implemented method of claim 53, further comprising generating, on production of an individualized contract header or basic function contract, a reference to a product template or a specific basic function for the product template.

64. A computer readable medium storing instructions that, when executed by a processor, performs the method of claim 53.
